(19) United States
(12) Patent Application Publication
(10) Pub. No.: US 2014/0035420 A1
(43) Pub. Date: Feb. 6, 2014

(54) PERMANENT MAGNET ROTOR AND METHOD FOR REDUCING TORQUE RIPPLE IN ELECTRIC MOTOR

(71) Applicant: JOHNSON ELECTRIC S.A., Murten (CH)

(72) Inventors: Yue LI, Hong Kong (CN); Maoxiong JIANG, Shenzhen (CN); Jian ZHAO, Shenzhen (CN); Yaming ZHANG, Shenzhen (CN); Hongjiang ZHAO, Shenzhen (CN); Haijun HUA, Shenzhen (CN)

(73) Assignee: JOHNSON ELECTRIC S.A., Murten (CH)

(21) Appl. No.: 13/956,837

(22) Filed: Aug. 1, 2013

(30) Foreign Application Priority Data
Aug. 1, 2012 (CN) 201210271436.5

(51) Int. Cl. H02K 1/27

(52) U.S. Cl. CPC H02K 1/274
USPC 310/156.47

(57) ABSTRACT

A permanent magnet motor (10) with reduced torque ripple and noise comprises a stator (20) and a rotor (30) divided into a plurality of rotor units (33). The rotors units include a plurality of structural features (38, 39, 40) to attach a plurality of magnetic components (35, 36). The rotor units are circumferentially staggered so that each rotor unit incrementally offsets from an adjacent rotor unit, thereby reducing the changes in magnetic flux as the rotor (30) spins, and thus reducing output ripples. The total offset between two end rotor units may be configured to be between a circumferential width of an outer surface of a structural feature (39) and an average circumferential width of a magnetic component (35).

### CROSS REFERENCE TO RELATED APPLICATION(S)

This application claims the benefit of Chinese Patent Application Serial No. 201210271436.5, which was filed on Aug. 1, 2012. The entire content of the aforementioned patent application is hereby incorporated by reference for all purposes.

### FIELD OF THE APPLICATION

Various embodiments described herein relate to reducing the torque ripple and noise in a permanent magnet motor.

### BACKGROUND

Permanent magnet motors, which may be found in many different applications, provide torque through the interactions between the magnetic fields produced by one or more permanent magnets with those of one or more field coils. In a typical permanent magnet motor, the field coils are mounted on a stator, often located within stator winding grooves or wrapped around one or more stator teeth, while the permanent magnets may be mounted on a rotor that spins within the stator. In another type of permanent magnet motor, the permanent magnets may instead be mounted on the stator, with the field coils being on the rotor.

During operation of most permanent magnet motors, as the rotor spins within the stator, the gap between the magnets and field coils changes depending on the rotor's position within the stator. The changes in the magnetic flux due to the changing gap causes fluctuations in the output torque of the motor. This is known as cogging or torque ripple, and is typically undesirable as it causes jerkiness, especially at lower motor speeds, and unwanted noise in the motor.

Thus, there is a need for implementing a permanent magnet motor with reduced fluctuations in output torque or lower torque ripple.

### SUMMARY

Some embodiments are directed at implementing a permanent magnet motor with decreased torque ripple and noise. Some embodiments are configured to reduce torque ripple by using a rotor comprising a plurality of rotor units or segments. The rotor units comprise a plurality of structural features, such as elongated indentations (e.g., grooves of various profiles), blind or through apertures, slots, or holes, allowing for a plurality of magnetic components to be attached or inserted into the rotor unit. The rotor units are staggered so that at least one rotor unit is circumferentially offset from an adjacent rotor unit, reducing the changes in magnetic flux as the rotor spins, and thus reducing torque ripple. In some embodiments, the total offset between the rotor units on the extremes of the rotor may be determined based at least in part upon a width of a magnetic component. For example, the total offset may be configured to be between a circumferential width of an outer surface of a structural feature and an average circumferential width of a magnetic component.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates an exemplary perspective view of a permanent magnet motor in some embodiments.

FIG. 2 illustrates an exemplary perspective view of a rotor used in a permanent magnet motor in some embodiments.

FIG. 3A illustrates an exemplary top view of a stator and rotor used in a permanent magnet motor in some embodiments.

FIG. 3B illustrates an exemplary top view of a rotor used in a permanent magnet motor in some embodiments.

FIG. 4 illustrates an exemplary side view of a rotor body used in a permanent magnet motor in some embodiments.

FIG. 5 illustrates an exemplary partial top view of a rotor in a permanent magnet motor in some embodiments.

### DETAILED DESCRIPTION

Various features are described hereinafter with reference to the figures. It shall be noted that the figures are not drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment does not necessarily have all the aspects or advantages shown.

An aspect or an advantage described in conjunction with a particular embodiment is not necessarily limited to that embodiment and may be practiced in any other embodiments, even if not so illustrated or explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

Embodiments are directed at reducing torque ripple and noise in permanent magnet motors. The permanent magnet motor may be a DC (direct current) motor powered by DC sources such as rectifiers or batteries, or an AC (alternating current) motor powered by AC sources. Some embodiments use a rotor axially divided into a plurality of rotor units or segments (hereinafter collectively referred to as rotor units). In some embodiments, a rotor comprises three or more rotor units. The rotor units may be individual separate components or layers in a single component. The rotor units may have structural features, such as, for example, grooves, channels, teeth, holes, or any other appropriate structural features that allow magnetic components to be mounted, inserted, or otherwise attached to the rotor unit. These structural features may be determined based at least in part upon, for example but not limited to, the geometric characteristic(s) of the magnets, the electromagnetic characteristic(s) of the magnets, the application(s) of the rotor, operational requirement(s) of the motor, any combinations thereof, etc.

The magnetic components may comprise one or more permanent magnets, one or more field coils, or any combinations thereof. Permanent magnets may refer to any material or object that is, once magnetized, capable of producing a persistent magnetic field without needing an electrical input, such as magnetized iron, nickel, cobalt, some alloys including certain rare-earth materials such as neodymium, praseodymium, etc., some naturally occurring magnetic materials, etc. Field coils may refer to any electromagnet or other device capable of generating a magnetic field when driven by an electric current. In various embodiments, the magnetic components are circumferentially placed around the rotor unit, preferably with similar or equal spacing so as to provide a more even magnetic field.

In some embodiments, the rotor units may include both primary and secondary magnetic components. The secondary magnetic components may be positioned relative to the primary magnetic components to increase the strength of the magnetic fields of the rotor. In some embodiments, a secondary magnetic component is positioned relative to two adjacent primary magnetic component by maintaining a substantially identical distance between the secondary magnetic component and each of the adjacent primary magnetic components. In addition or in the alternative, the secondary magnetic components also help to lower torque ripple by creating a more uniform magnetic field for the rotor, reducing variations in magnetic flux as the rotor spins.

In various embodiments, the rotor units are circumferentially staggered so that each rotor unit incrementally offsets from the previous rotor unit with an offset, which may be constant or vary from unit to unit. The total amount of offset between the rotor units on two extremes of a rotor may be determined at least in part upon a size (e.g., width or other dimensions) of a primary magnetic component or on a size (e.g., width or other dimensions) of a structural feature that accommodates a primary magnetic component. For example, the total offset may be configured to be between a circumferential width of an outer surface of a structural feature and an average circumferential width of a corresponding magnetic component. The staggered rotor units help to smooth out the fluctuations of the magnetic flux during operation, lowering undesired torque ripple and reducing noise.

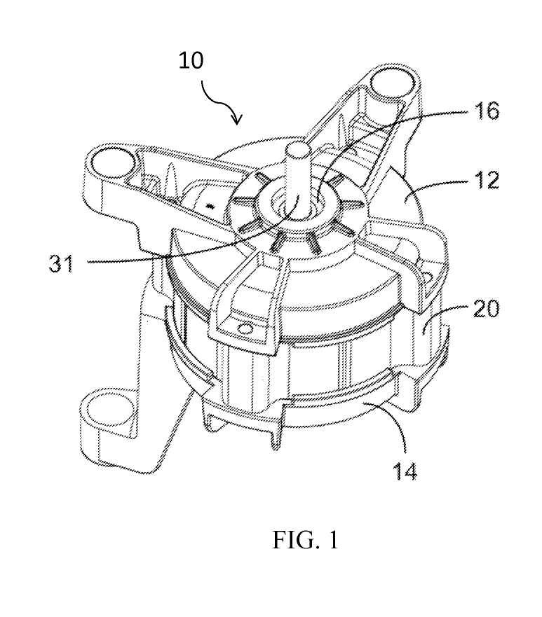

FIGS. 1-4 illustrate a permanent magnet motor in accordance with some embodiments. It is appreciated that the permanent magnet motor 10 may take on a variety of different shapes and forms differing from those illustrated in the figures. Also, while the illustrated embodiments depict the permanent magnets as being mounted on the rotor and the field coils as being on the stator, it will be appreciated by those skilled in the art that alternate embodiments may have the permanent magnets be mounted on the stator and the field coils on the rotor.

As illustrated in the figures, permanent magnet motor 10 comprises a stator 20 and a rotor 30. Motor 10 may additionally comprise an outer cover. In some embodiments, the outer cover may be divided between a upper cover portion 12, and a lower cover portion 14, such that stator 20 and rotor 30 are located between upper and lower cover portions 12 and 14. In some embodiments, stator 20 may be directly mounted to portions of the outer cover through connectors such as bolts, rivets, or screws. Cover portions 12 and 14 may contain one or more bearings 16, sleeves, or any other components that provide mechanical coupling between moving and stationary parts to allow a rotor shaft 31 connected to rotor 30 to pass through the cover 12, thereby allowing for the output from the motor 10 to be transferred directly or indirectly via a transmission mechanism to an external application, such as an axle, pulley, or gear, etc.

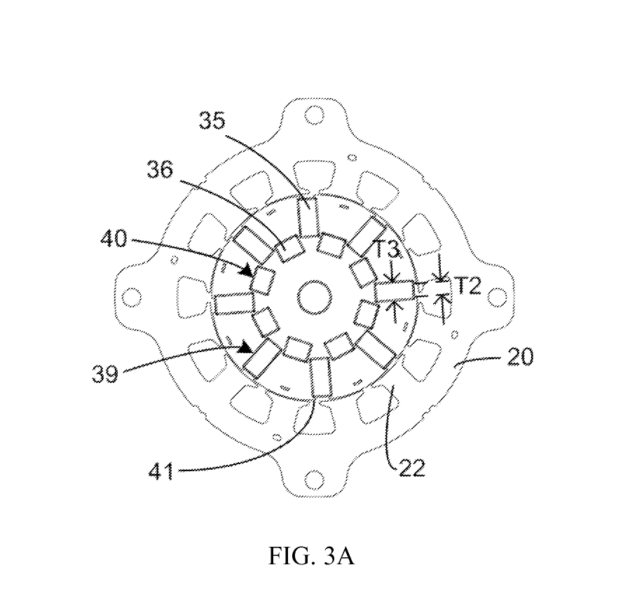

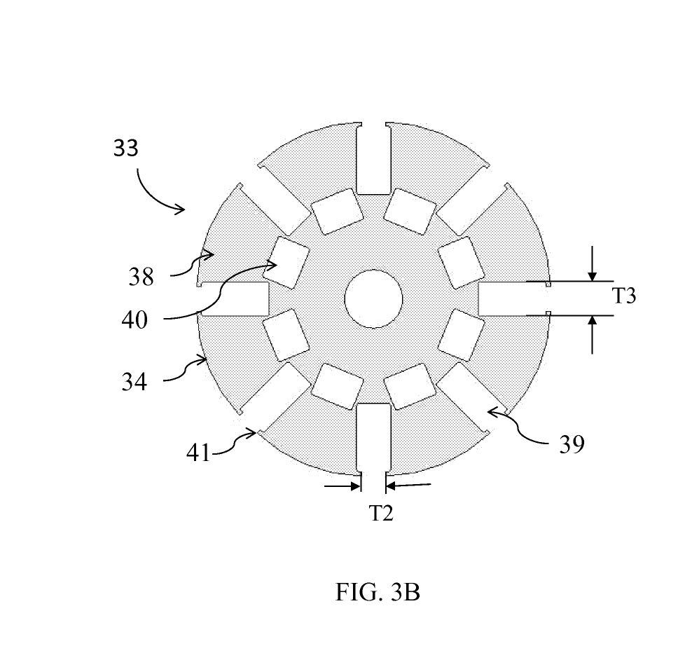

Stator 20 may comprise one or more field coils for generating a magnetic field when energized. In some embodiments, stator 20 may comprise a plurality of stator teeth 22 in a circumferential arrangement. In some embodiments, stator 20 may be in a substantially hollow cylindrical form, and the stator teeth 22 are spaced in equal intervals around an inner surface thereof. It shall be noted that the term “substantially” or “substantial” such as the “substantially hollow cylindrical form” is used herein to indicate that certain features, although designed or intended to be perfect (e.g., perfectly cylindrical), the fabrication or manufacturing tolerances, the slacks in various mating components or assemblies due to design tolerances or normal wear and tear, or any combinations thereof may nonetheless cause some deviations from this designed, perfect characteristic. Therefore, one of ordinary skill in the art will clearly understand that the term “substantially” or “substantial” is used here to incorporate at least such fabrication and manufacturing tolerances, the slacks in various mating components or assemblies, or any combinations thereof. The field coils may be wrapped around or otherwise attached to the stator teeth 22. For example, FIG. 3A illustrates a stator 20 with twelve equally-spaced stator teeth 22. A field coil may be wrapped around a stator tooth 22, providing a magnetic field for when the motor is in operation.

Rotor 30 comprises an output shaft 31 and a rotor body 32. Rotor body 32 is configured to spin within stator 20, while output shaft 31 may extend outside stator 20 so that the output torque of the motor 10 can be transferred directly or indirectly through a transmission mechanism to an external application such as, for example, an axle, pulley, gear, etc. Rotor body 32 may be substantially cylindrical in form, and include one or more permanent magnets for generating magnetic fields. During operations, the magnetic fields of the permanent magnets mounted on rotor body 32 interact with those of the field coils on stator 20 to generate the output that rotates the output shaft 31.

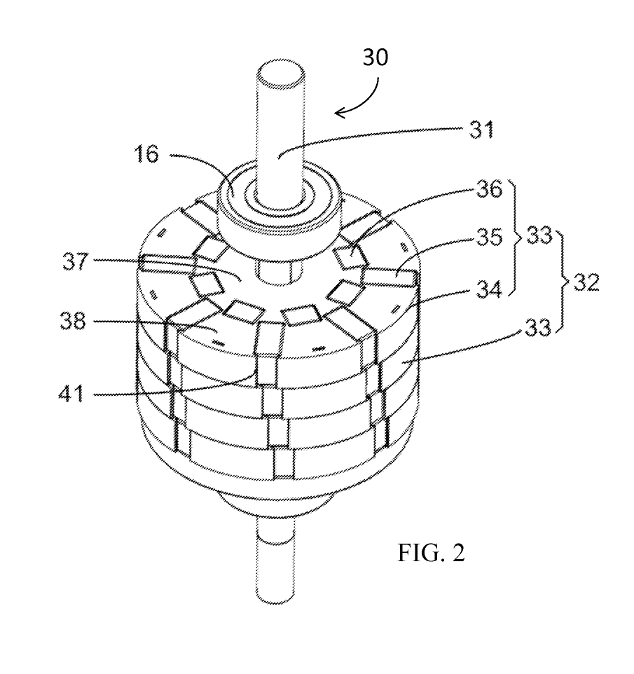

Rotor body 32 may comprise a plurality of rotor units 33. In some embodiments, rotor body 32 comprises three or more rotor units 33. In some embodiments, the plurality of rotor units 33 are identical to each other. In some other embodiments, at least one rotor unit 33 is different from the remaining rotor unit(s). For example, in the embodiment illustrated in FIG. 2, rotor body 32 comprises four rotor units 33. In some embodiments, rotor units 33 may be separate components, while in other embodiments, rotor units 33 may be different portions or layers of a singular, inseparable rotor body 32.

Each rotor unit 33 may include a core portion 34 on which a plurality of primary permanent magnets 35 may be mounted, inserted, or otherwise attached. In some embodiments, core portion 34 may comprise a central yoke portion 37 attached or otherwise fixed to output shaft 31, and a plurality of structural features to which the primary permanent magnets 35 may be mounted, inserted, or attached. In some embodiments, yoke 37 is metallic and substantially circular or ring-shaped.

The structural features of core 34 may comprise a plurality of receiving through or blind grooves 39 defined by a plurality of rotor teeth 38. In some embodiments, such as the one illustrated in FIGS. 2, 3A, and 3B, rotor teeth 38 may be outward-extending and circumferentially arranged around the outside of central yoke portion 37. The outer edge of the side of each of rotor teeth 38 may optionally include a flange 41 for supporting the outer surface of a primary magnet 35 placed within the grooves 39. In some embodiments, flange 41 has a width of between 0.8 millimeter (mm) and 1.2 mm, preferably about 1 mm. It is understood that other types of structural features may be utilized in addition to or instead of receiving grooves 39, such as through or blind holes, apertures of other shapes, or sockets in which primary magnets 35 may be inserted.

In some embodiments, the rotor teeth 38 of rotor body 32 are identical in size and spaced in substantially equal intervals around the circumference of rotor body 32, such that the primary magnets 35 are substantially equally spaced around the rotor unit 33 in the circumferential direction. For example, FIGS. 2, 3A, and 3B illustrate a rotor unit 33 having eight identically sized (as designed but not necessarily as manufactured) rotor teeth 38 defining eight identically sized (also as designed but not necessarily as manufactured) receiving grooves 39 that are substantially equally spaced around the outside of yoke 37.

The width of the outer edge of each receiving groove 39 is measured as T2, as indicated in FIG. 3A. The average width of each primary magnet 35 in the circumferential direction may be measured as T3, as indicated in FIG. 3A. In some embodiments, T2 may be measured as the distance between the flanges 41 of a corresponding groove 39. In alternate embodiments, where receiving groove 39 may be instead a blind or through receiving hole, aperture, or slot, T2 may instead measure the circumferential width of an outer edge of the blind or through receiving hole, aperture, or slot.

In some embodiments, each rotor unit 33 may also comprise a plurality of secondary permanent magnets 36. Each of the secondary permanent magnets 36 may be arranged relative to a pair of adjacent primary magnets 35. For example, as illustrated in FIGS. 2 and 3A, the yoke portion 37 may have a plurality of receiving blind or through holes, apertures, openings, countersinks, counterbores, etc. (collectively holes) 40, arranged relative to pairs of adjacent receiving grooves 39, for which to house secondary magnets 36. It will be appreciated that other shapes and configurations for the secondary magnets 36 are also possible. Secondary magnets 36 are used in some applications to increase the strength or uniformity of the magnetic fields of rotor 30 that interact with the field coils of stator 20, allowing for increased output torque. In addition, by positioning the secondary magnets 36 relative to the primary magnets 35, fluctuations in the magnetic field as the rotor 30 spins within the stator 20 may be reduced, lowering undesirable torque ripple or cogging experienced by the motor 10 in operation.

In the illustrated embodiments, the same pole of a primary magnet 35 and a corresponding secondary magnet 36 may be configured to face the same rotor tooth 38, so that in operation, the magnetic fields from the primary and secondary magnets 35 and 36 neighboring each rotor tooth 38 (in the illustrated embodiment, one secondary magnet 36 and two primary magnets 35) are more concentrated in the rotor tooth 38, creating a stronger magnetic field for the rotor 30.

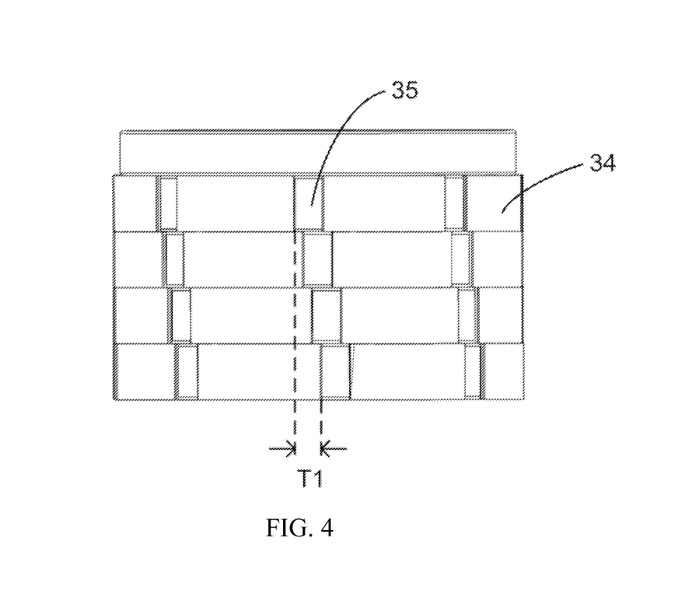

In various embodiments, each of the rotor units 33 is circumferentially offset from the immediately adjacent rotor unit(s) 33. In accordance with some embodiments, the offset amount between any two immediately adjacent rotor units 33 is substantially constant. In some other embodiments, at least one offset between two adjacent rotor units 33 is different from the remaining offset(s). As illustrated in FIG. 4, the total amount of the offset between the rotor units 33 may be measured by offset T1 in some embodiments.

In some embodiments, the amount of the total offset T1 is based at least in part on the width of the structural features and/or the magnets 35 and 36 in the rotor units 33, and not upon a number of magnets in the rotor 30 or upon a shape or feature of the stator 20. In some embodiments, T1 may be configured to have a value between T2 and T3. For example, in the embodiment illustrated in FIGS. 1-4, T1 is configured to be greater than or equal to T2, but less than or equal to T3. By offsetting the rotor units 33, the magnetic field generated by the permanent magnets in of the rotor 30 is made more constant or uniform over time, resulting in less output torque fluctuation, reducing undesirable torque ripple and noise during operation of the motor.

It is understood that components of motor 10 may take on different forms and shapes than those shown in the preceding figures. For example, while the preceding figures have illustrated the cross-section of magnets 35 and 36 to be substantially rectangular, they may also be formed in other shapes, so long as circumferential magnetic polarization or a desired magnetic field is maintained.

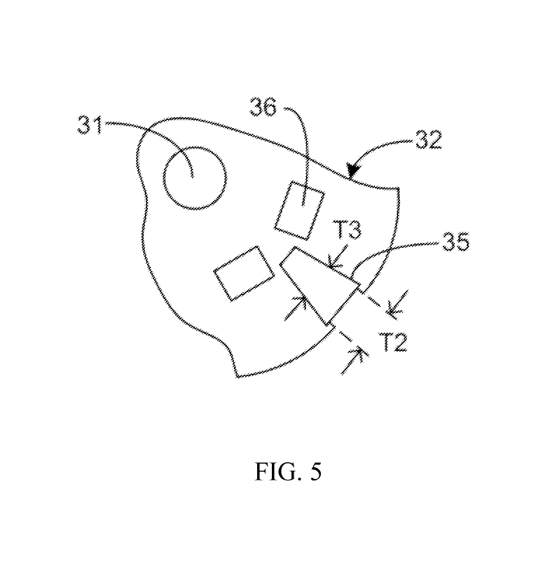

FIG. 5 illustrates top view of a portion of a rotor 30 in accordance with some embodiments, wherein the cross-section of the primary magnets 35 is substantially trapezoidal in shape, increasing in width away from shaft 31. This shape configuration may be used in some embodiments to produce a stronger field in or around the rotor 30 to interact with the magnetic fields produced by the field coils in stator 20. In this embodiment, the total offset of the rotor units 33 in rotor body 32 (T1) is configured to be less than or equal to the width of the outer edge of receiving groove 39 (T2), and greater than or equal to the width of the primary magnet 35 in the circumferential direction (T3).

Alternatively, in other embodiments, the wider end of a primary magnet 35 may be located radially inwards, closer to shaft 31. In such an embodiment, flange 41 may no longer be necessary to support the magnet 35 in the groove 39. T1 may be configured to be greater than or equal to T2, but less than or equal to T3.

In some embodiments, the stator 20 has a total of twelve stator teeth 22. Rotor 30 may comprise four rotor units 33. Each rotor unit 33 may comprise eight rotor teeth 38. The offset between adjacent rotor units 33 may be 2.5 degrees times the radius of rotor 30, such that the total value of T1 is 7.5 degrees times the radius of rotor 30. Experimental results have shown that the above exemplary configuration is able to achieve high motor efficiency with good noise suppression.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. A rotor for a permanent magnet motor, comprising:
a plurality of first magnetic components; and
a rotor body comprising a plurality of rotor units in a stack arrangement, wherein:
a rotor unit of the plurality of rotor units comprises a plurality of structural features to attach at least one of the plurality of first magnetic components,
the plurality of rotor units are circumferentially offset by at least one offset between two neighboring rotor units in the stack arrangement, and
a total offset of the plurality of rotor units is based at least in part upon a width of a first magnetic component of the plurality of first magnetic components.

2. The rotor of claim 1, wherein the plurality of first magnetic components comprise a plurality of permanent magnets.

3. The rotor of claim 1, further comprising a plurality of second magnetic components circumferentially spaced around the plurality of rotor units relative to the plurality of first magnetic components.

4. The rotor of claim 1, wherein the plurality of rotor units comprise at least three rotor units.

5. The rotor of claim 1, wherein:
each of the plurality of rotor units includes a central yoke portion and a plurality of rotor teeth extending radially from the central yoke portion;
the plurality of structural features of the rotor unit comprise a plurality of elongated indentations defined by the plurality of rotor teeth; and
the plurality of first magnetic components are inserted into the plurality of elongated indentations in the plurality of rotor units.

6. The rotor of claim 5, wherein the structural features further comprise a plurality of flanges on an outside edge of the plurality of elongated indentations.

7. The rotor of claim 6, wherein the width of one flange of the flanges comprises a value between 0.8 millimeter and 1.2 millimeters.

8. The rotor of claim 5, wherein each rotor unit comprises eight rotor teeth.

9. The rotor of claim 5, further comprising a plurality of second magnet components, wherein the plurality of rotor units further comprise a plurality of receiving apertures configured to receive the plurality of second magnetic components.

10. The rotor of claim 1, wherein an offset of the at least one offset between two neighboring rotor units in the stack arrangement is 2.5 degrees.

11. The rotor of claim 1, wherein the total offset of the plurality of rotor units in the stack arrangement is 7.5 degrees.

12. The rotor of claim 1, wherein a cross-sectional profile of the first magnetic component perpendicular to an axis of an output shaft is substantially trapezoidal.

13. The rotor of claim 1, wherein the total offset of the plurality of rotor units in the stack arrangement is configured to be between an average width of the first magnetic component and a width of an outside edge of the structural feature.

14. A method for reducing output ripples in a permanent magnet motor, comprising:
configuring a rotor in the motor that comprises a plurality of rotor units, wherein a rotor unit of the plurality of rotor units comprises a plurality of structural features to attach a plurality of first magnetic components; and
circumferentially offsetting the plurality of rotor units by at least one offset, such that a total offset between two end rotor units is determined based at least in part upon a width of a first magnetic component of the plurality of first magnetic components.

15. The method of claim 14, wherein configuring a rotor in the motor includes configuring the rotor to comprise at least three rotor units.

16. The method of claim 14, wherein configuring a rotor in the motor includes configuring the rotor units to further comprise additional structural features to attach a plurality of second magnetic components to the rotor units, such that the second magnetic components are located relative to adjacent pairs of the first magnetic components.

17. The method of claim 14, wherein the total offset is 7.5 degrees.

18. The method of claim 14, wherein the total offset is between an average width of a first magnetic component and a width of an outside edge of a structural feature.

19. A permanent magnet motor, comprising:
a stator, comprising:
a plurality of stator teeth; and
a plurality of field coils attached to the plurality of stator teeth;
a rotor, comprising:
a plurality of first magnetic components; and
a rotor body comprising a plurality of rotor units in a stack arrangement,
wherein:
a rotor unit of the plurality of rotor units comprises a plurality of structural features to attach at least one of the plurality of first magnetic components,
the plurality of rotor units are circumferentially offset by at least one offset between two neighboring rotor units in the stack arrangement, and
a total offset of the plurality of rotor units is based at least in part upon a width of a first magnetic component of the plurality of first magnetic components.

20. The permanent magnet motor of claim 19, wherein the stator comprises twelve stator teeth.
